(19) United States
(12) Patent Application Publication
(10) Pub. No.: US 2011/0010227 A1
(43) Pub. Date: Jan. 13, 2011

(54) Anti-rigging Voting System and Its Software Design

(75) Inventor: Ky Minh Vu, Ottawa (CA)

Correspondence Address: Ky Vu, 3717 Sixth Street, Ottawa, ON, K1T 1K5, CA

(73) Assignee: AULAC TECHNOLOGIES INC., Ottawa (CA)

(21) Appl. No.: 12/830,444

(22) Filed: Jul. 6, 2010

(30) Foreign Application Priority Data
Jul. 8, 2009 (CA) CA2671269

(51) Int. Cl. G06Q 50/00; G06F 17/30; H04L 9/32; G06Q 10/00

(52) U.S. Cl. 705/12; 707/803; 707/E17.005; 726/7

(57) ABSTRACT

The hardware and software of the voting system of an election are described. The hardware consists of a number of computers: desktops or notebooks. The software consists of a number of programs running on these computers to produce a number of spreadsheet files of which election results can be displayed and verified. These spreadsheet files are protected with a password to prevent alterations. A voter also needs passwords for the authenticity of the vote. The vote is then entered into computer memory cells, the spreadsheet files and printed out on a piece of paper for the ballot box. This triple action will make the alteration of the election result difficult and enhance the honesty of the election.

### Field of the Invention

This invention relates to the voting system of an election. The invention suggests the hardware and the software for the system. It presents algorithms in the software of the computer to count votes, verify and establish results. It also proposes a method to protect the results for an honest election.

### BACKGROUND OF THE INVENTION

The voting system of an election, which consists of the hardware (ballot boxes, paper), software (vote counting, organizational chores) and method (open or closed), is a symbol of a democratic society. It has existed since the emergence of modern, democratic western powers. While the concept can be essentially the same, the hardware, software and method must be changed to reflect the state of technology in a modern society.
The biggest concern of an election is its honest result and peaceful-acceptance aftermath. If this concern cannot be guaranteed, the principle of democracy is in jeopardy. There has been rumors that honesty has not been achieved in many elections, even in more democratic countries. Problems such as wrong counting, ghost voters and result alteration that can change the result of an election are rampant.
Since election is an important issue in a democratic society, there are many patent applications for a better system or method to vote. Voting exists not only in a political arena but also in a corporate world. And the method and apparatus should be the same for a small or big election. In the Canadian patent database, we can cite many patent applications. The very recent one is the patent application CA2531618 with the title System and Method for Electronic Voting and owner Unie Van Waterschappen. It was applied through the Patent Cooperation Treaty (PCT) from The Netherlands with the PCT filing number PCT/NL2004/000496. The problem with this patent is that it requires new hardware, so there is more cost involved. Since new hardware has to be designed, there is a possibility for its failure. Another patent application is CA2469146 with the owner Amerasia International Technology Inc. The patent is applied through PCT from the United States of America with the PCT filing number PCT/US2001/045769. It has the title Electronic Voting Apparatus, System and Method. While the patent uses a computer, which will reduce the cost and possibility of a failure of the new hardware, it still needs new gadgets like smart cards and a reader of these smart cards to produce an additional vote count. The system and method is not cost effective and efficient.
With a modern approach, suggested in this patent application, most if not all problems that can result in a dishonest outcome of an election can be eliminated. The approach uses the most advanced hardware known to mankind, a notebook computer, to doubly count the votes. This method will prevent wrong counting and ghost voters. It uses a voter's passwords to authenticate a vote and an election password to lock the computer files after voting time to prevent result alteration. It uses the Internet for remote voters to reduce the cost of voting. It is the most modern, efficient, economical and advanced method to vote in an election.

### SUMMARY OF THE INVENTION

It is the object of this invention to introduce a modern and anti-rigging method to the voting system of an election in a democratic society.
It is a further object of this invention to introduce an effective, efficient and economical method to the voting system of an election to enhance its value in a democratic society.

### BRIEF DESCRIPTION OF THE DRAWINGS

FIG. 1. Block diagram of a vote station.

FIG. 2. Flow chart of the voting program.

### DESCRIPTION OF THE PREFERRED EMBODIMENT

The election, a symbol of the people's will and voices, is a proud product of modern democratic societies. From the time of its beginning, the election has changed relationship between men in a society. While its concept has not changed today, the method to carry it out must be changed to reflect changes in a modern society. This invention suggests a new method to carry it out in modern democratic societies, in the new millennium. This method is described in the following discussion.

Method

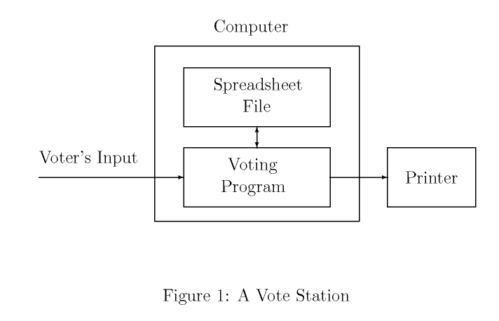

For a successful election, it must have: an honest election result and a cost efficient operation. Luckily enough, the digital computer in the modern era can provide a solution for both requirements. It can give an efficient correct vote count with a cost, which can only be described as meaningless. The digital computer is hence an indispensable tool for an election in the modern era. A voting system must have, at its core, a number of computer with their hardware and software. The hardware consists of a number of computers notebooks or desktop and printers. The computer notebooks are preferred for their mobility and energy efficient. The software consists of a number of computer programs running on these notebooks. Before election days, one program is run to create a number of spreadsheet files containing information of voters. Depending on the number of voting locations in a city and the number of eligible voters, the program determines the number of needed vote stations. FIG. 1 shows the block diagram of a vote station. Each vote station consists of a notebook, a printer and a number of the spreadsheet files that reside in the notebook and contain the information of voters. Each voter is assigned to a particular vote station. This creates an orderly conduct at a voting location and prevents the case in which a voter can vote more than once. On election days, another program is run, and it checks the identity of a voter before accepting his vote, at his assigned station. The vote will be entered into computer memory cells as well as the spreadsheet files. The vote is then printed out with the information of the voter for a record of the vote. This record can also be put in a locked ballot box for an independent count or kept as an evidence of the vote. The ballot boxes can also serve the purpose of a recount in the case of a request. For an additional assurance of honesty, each printed record consists of two identical parts. One part can be separated and put into a ballot box; the remaining part is kept by the voter. A voter can compare his vote on this record with the vote shown on the final display from the spreadsheet files, which can be made available on a website for a period of time. If the supporters of an electoral candidate check and find discrepancies among the votes, they can demand a recount of the votes stored in the physically locked ballot boxes. At the ending moment of the election, the final result of the votes on each notebook is written onto a separate text file and printed out on a piece of paper as a hard copy evidence; the spreadsheet files are then locked with a password so that the voting results cannot be altered. Independent tallies from the spreadsheet files, the computer memory cells and the ballot boxes will greatly prevent vote rigging. The election consists of a number of voting locations or centers: a main center and a number of distributed centers. Each distributed voting center consists of a number of vote stations. All the notebooks from the distributing centers are brought back to the main center for the final tally. The main center can be connected to the Internet, with a website, for remote voters. A remote voter votes in the same manner as other voters, which means the voter answers the same set of questions as other voters. Remote voters define a special group of voters that have difficulty to go to a voting location. Canadian soldiers fighting overseas belong to this group of voters. Handicapped or sometimes senior citizens also belong to this group because they have difficulty to go to a voting location. Because of the authentication process, only voters having their names on a spreadsheet file can vote at the station having the spreadsheet file, special arrangement must be made before this vote station can be set up. A ballot box must also exist at this vote station, and a staff of the election personnel must take the vote printed out and put it in the ballot box for a remote voter. A record of the vote can also be printed out at the location of the remote voter. The distributed centers, however, are not connected to the Internet to prevent sabotage from hostile nations or hackers.

Software Structure

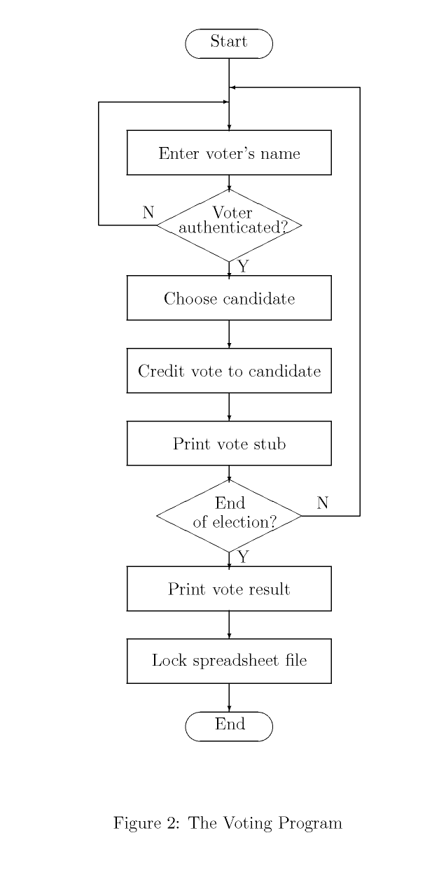

The software contains three main programs of which one creates a database of eligible voters and store it in spreadsheet files and one takes the votes of voters, does the counting, prints the voting results and locks the spreadsheet files with a password. The third program does the final tally by adding the results from all the spreadsheet files. The voting results from the spreadsheet files must agree with the results printed out from a text file at the ending moment of the election. The results from the text file must be the most truthful results; because, from the time of the beginning of the election to the time of its creation, there is no human interference in this process.
For a small election or in a special case, it might not be necessary to run the program to create the voter database and the program to do the final tally because these tasks can be done by hand. Therefore, only the program to accept and count the votes is described here.
The voting program is the program that takes the vote of a voter and counts the votes for each electoral candidate. The program first asks the voter's names, then it asks for two identification numbers. In Canada, these two identification numbers can be the Social Insurance Number (SIN) and the date of birth, written as a single number in the form YYYYMMDD, for example 19900205. In this form, if the date-of-birth number is bigger, the person is younger. And the program has an easy time to check if a voter is eligible to vote. If the voter enters correct information, the program will proceed and display a list of candidates for the voter to choose. The program then credits the chosen candidate with a vote. Then the program checks for the end-of-election time. If the real time is the closing time of the election, the program will print out the number of votes for all the candidates, lock the spreadsheet files and shut itself down. If the real time is not the closing time of the election, the program will return and wait for another voter. FIG. 2 shows the flow chart of this program.

What I claim as my invention is:

1. A method to organize an electronic voting system containing a number of computer notebooks with a number of software programs of which one registers the votes of voters, one does the final count of the total number of votes for each electoral candidate and one creates a database of voters each of which contains the following information:
(a) family name,
(b) first name,
(c) first middle name,
(d) encoded first identification number,
(e) encoded second identification number,
(f) address,
(g) telephone number,
(h) list of electoral candidates
allocated in columns of a same row of a spreadsheet file whose name is particular to the location of the vote and the notebook.

2. A method to vote electronically with the electronic voting system described in claim 1 in which a voter carries out, at the voter's station, the following steps:
(a) answering questions to the voter's names,
(b) answering secret personal identification numbers used as passwords,
(c) verifying the voter's final personal data, displayed on the notebook, as a proof that the voter has responded correctly to the passwords entered in step (b),
(d) choosing an electoral candidate by picking the chosen one from a displayed list of candidates,
(e) picking a printed-out sheet of paper from the printer of the voter's station and proceeding to the ballot box.

3. A method to generate a triple count of the votes in the electronic voting system described in claim 1, which consists of the following steps:
(a) crediting the electoral candidate, chosen by a voter in claim 2, by changing a cell in the spreadsheet file at the row corresponding to the voter and at the column corresponding to the candidate from the initial value zero to one,
(b) activating the auto sum feature in the spreadsheet file to display the total number of votes, in a cell of the spread-sheet file, for the candidate as the first counting method,
(c) incrementing the value of the number of votes—as a variable in the computer program that accepts the electronic vote on election days—for the chosen candidate as the second counting method,
(d) separating the voting-result sheet, printed out in claim 2, into two identical parts of which the voter keeps one and deposits the other in a locked ballot box for the third counting method.

4. A method to prevent alteration of the result of an election, using the electronic voting system described in claim 1 in which the computer program that accepts the electronic vote—at the ending moment of the election—carries out the following steps:
(a) electronically generating a random password,
(b) locking the spreadsheet file on the notebook of each vote station with the random password generated in step (a) or with a predetermined password,
(c) writing the voting results for each electoral candidate into a computer text file,
(d) printing out the computer text file, produced in step (c), on sheets of paper for some electoral personnel to collect.

5. A method to declare the final result of the election which consists of the following steps:
(a) verifying that each spreadsheet file reporting the same result as the text file printed out by the printer of the same vote station,
(b) collecting all the spreadsheet files together on one notebook,
(c) running the program, mentioned in claim 1, that does the final tally of votes for the electoral candidates,
(d) printing out the final result obtained from step (c).

6. A method to vote remotely for a remote voter, which consists of the following steps:
(a) entering the website of the main voting center for remote voters,
(b) answering questions to the voter's names,
(c) answering secret personal identification numbers used as passwords,
(d) verifying the voter's final personal data, displayed on the notebook, as a proof that the voter has responded correctly to the passwords entered in step (c),
(e) choosing an electoral candidate by picking the chosen one from a displayed list of candidates,
(f) picking a printed-out sheet of paper from the printer of the voter's station.
